(19) United States
(12) Patent Application Publication
(10) Pub. No.: US 2026/0242305 A1
(43) Pub. Date: Aug. 20, 2026

(54) POTASSIUM BASED MICRONUTRIENTS CHELATED COMPOSITION FOR FOLIAR APPLICATION AND PREPARATION PROCESS THEREOF

(71) Applicants: Aniruddha Dattatray KAPADNIS, NASHIK (IN); Harshal TAMBAT, NASHIK (IN)

(72) Inventors: Aniruddha Dattatray KAPADNIS, NASHIK (IN); Harshal TAMBAT, NASHIK (IN)

(21) Appl. No.: 19/157,705

(22) PCT Filed: Jul. 10, 2023
(86) PCT No.: PCT/IN2023/050673

§ 371 Date: Aug. 19, 2025

(30) Foreign Application Priority Data
Mar. 1, 2023 (IN) 202321013940

(51) Int. Cl. C05F 11/00; C05B 1/00; C05D 1/00

(52) U.S. Cl. CPC C05F 11/00; C05B 1/00; C05D 1/00

(57) ABSTRACT

The present invention relates to a micronutrient fertilizer composition for foliar application comprising at least one chelated micronutrient or more chelated micronutrient. More preferably, the present invention provides a 100% water soluble micronutrient chelated fertilizer composition for enrichment of micronutrients content and phosphorous content in plants comprising potassium based 1-Hydroxyethylidene-1,1-diphosphonic acid (HEDP) and metals, wherein the complex consisting of 0.085-0.33 weight % of Metal source, 0.19-0.40 weight % of Potassium (K₂O) source and 0.40-0.60 weight % of Phosphorus (P₂O₅) source that of total weight of Metal-Potassium-Phosphorus source so that it provides a highest availability of Metal-P₂O₅ with no risk of scorching to the crop and plant.

### FIELD OF INVENTION

The present invention relates to a micronutrient fertilizer composition for foliar application comprising at least one fully chelated micronutrient or more fully chelated micronutrient. More preferably, the present invention provides a 100% water soluble micronutrient chelated fertilizer composition for enrichment of micronutrients content, Potassium and phosphorous content in plants. The present invention also provides a process of preparation of 100% water soluble micronutrient chelated fertilizer composition.

### BACKGROUND AND PRIOR ART OF THE INVENTION

Foliar fertilizers are fertilizers that are designed to be applied directly to the leaves of a plant. It is common for crops to receive foliar fertilizers on a regular basis, for instance to boost their growth or to correct micronutrients deficiencies.

As micronutrients (Metals) such as Zinc, Calcium, Manganese, Copper, Magnesium, Cobalt, Iron, Molybdenum, Boron are essential constituents required for health growth of any plant along with basic Nitrogen, Phosphorous and Potassium content. Micronutrient malnutrition has been recognized as a gigantic and rapidly growing public health problem not only amongst the poor but also across the whole spectrum of people living on an unbalanced diet dominated by a single staple grain. Among the micronutrients, Zn is the most limiting nutrient whose deficiency is a wide spread nutritional disorder in some of staple food like rice.

Foliar application is done with spraying a mist of fine water droplets through small spray nozzles. Typically, foliar applied fertilizers should completely soluble in water or dispersed in a such a good way that the spraying nozzles are not blocked.

It is well known in the art that, when Metals/Minerals are chelated, micronutrients are absorbed by plant leaves more quickly than when applied as crystalline salts, therefore becoming available to plants rapidly. As chelated fertilizers are normally more effective than crystalline salts (Sulphate/acetate) composed of the same nutrients at the same molar concentration, a lower rate of chelated fertilizer is needed. This markedly reduces the final expenditure required for peak performance.

The chelate formation process by which the central ions (metal) are combined with two or more coordination atoms with the same multi-tooth ligands is called chelation. The result of chelation is cationic cation (Ca²⁺, Mg²⁺) and chelating agent interacts to produce stable chelate. This prevents them from reacting with scale anions (such as CO₃²⁻, SO₄²⁻, PO₄³⁻ and SiO₃²⁻). That greatly reduces the probability of scaling. Chelation is carried out stoichiometrically. Therefore, if the complex is not fully chelated (i.e. substantially fully chelated), there is high chances of having undissolved metal particles in said spraying solution that may clock the nozzle or remain unabsorbed thereby become inefficient formulation.

Plant leaves are normally very tolerant of chelates. In contrast, mineral salts often cause leaf burning after foliar application. Mineral chelates dissolve very easily in water.

The EDTA Chelate fertilizer does not have Phosphorous source and due to high cost of EDTA and metal oxides, EDTA Chelate has higher cost.

The chelated product which will be having 100% water soluble form is an essential part of fertilizer composition to provide an accurate concentration of deficient metal/Mineral. Because, they form clear solutions, without sediments or precipitates. This guarantees a high level of effectiveness and stops the nozzle becoming blocked. Even 0.1% sedimentation is undesired for foliar application.

Therefore, the present invention solving the problem of foliar application micronutrient chelated fertilizer composition having 100% chelated Metal/mineral thereby solving the above said prior art problem.

### OBJECTIVES OF THE INVENTION

It is an objective of the present invention to provide a complete water soluble micronutrient fully chelated complex powder composition for foliar application having source of Metal, Potassium and Phosphorus therein.

Another specific objective of the invention is to provide a fertilizer comprising a metal micronutrients which are chelated with Potassium based 1-Hydroxyethylidene-1,1-diphosphonic acid (HEDP) with clear solubility in water without any settling.

One of the objective of the invention to provide a fertilizer composition having neutral pH as it is very safe and provides a highest availability of Metal-P₂O₅ with no risk of scorching to given crop and plant so that provides a highest benefits with maximum uptake.

In an aspect, the present invention provides a method of preparation of fertilizer comprising a metal micronutrients which are chelated with potassium based 1-Hydroxyethylidene-1,1-diphosphonic acid (HEDP) with clear solubility in water without any settling, comprising of a chelated complex of metals potassium based 1-Hydroxyethylidene-1,1-diphosphonic acid (HEDP), wherein the complex consisting of 0.085-0.33 weight % of Metal source, 0.19-0.40 weight % of Potassium (K2O) source and 0.40-0.60 weight % of Phosphorus (P₂O₅) source that of total weight of Metal-Potassium-Phosphorus source on anhydrous basis.

### SUMMARY OF THE INVENTION

Towards a sustainable agricultural development, crops need to be provided with effective fertilizer composition containing one or more essential plant micronutrients that are immediately or potentially available in sufficiently good amounts without remaining in unabsorbed form due to insolubility issues in water while foliar application. To fulfil the above desired crop requirement, the present invention provides a complete water soluble micronutrient chelate complex powder for foliar application.

More preferably, the present invention provides a micronutrient based chelated composition for foliar application and preparation process thereof which is having 100% water soluble fully chelated complex of metal-dipotassium HEDP (hydroxy ethylidene di phosphonic acid), wherein the said composition can for a clear aqueous solution in concentration between 0.0001 to 60% w/w or above without any particle settling, precipitation or sedimentation therein.

In an important embodiment, the present invention provides a complete water soluble micronutrient chelate complex powder having source of Metal, Potassium and Phosphorus comprising of: Chelated complex of metals potassium based 1-Hydroxyethylidene-1,1-diphosphonic acid, wherein the complex consisting of 0.085-0.33 weight % of Metal source, 0.19-0.40 weight % of Potassium (K₂O) source and 0.40-0.60 weight % of Phosphorus (P₂O₅) source that of total weight of Metal-Potassium-Phosphorus source on anhydrous basis; Charactered in that the metal is fully chelated with potassium based 1-Hydroxyethylidene-1,1-diphosphonic acid (HEDP) with clear solubility in water without any settling.

Wherein, the metals are selected from Zinc, Calcium, Manganese, Copper, Magnesium, Cobalt, Iron, Molybdenum, Boron or mixture thereof and potassium based 1-Hydroxyethylidene-1,1-diphosphonic acid is selected from potassium and dipotassium form.

In an one embodiment of the present invention, the chelated complex zinc dipotassium 1-Hydroxyethylidene-1,1-diphosphonic acid consisting of 0.21-0.22 weight % of Zinc (Zn) source, 0.30-0.40 weight % of Potassium (K₂O) source and 0.40-0.50 weight % of Phosphorus (P₂O₅) source that of total weight of Zinc-Potassium-Phosphorus source on anhydrous basis.

In second embodiment of the present invention, the chelated complex of Calcium dipotassium 1-Hydroxyethylidene-1,1-diphosphonic acid consisting of 0.14-0.15 weight % of Calcium (Ca) source, 0.30-0.40 weight % of Potassium (K₂O) source and 0.50-0.60 weight % of Phosphorus (P₂O₅) source that of total weight of Calcium-Potassium-Phosphorus source on anhydrous basis.

In third embodiment of the present invention, the chelated complex of Manganese dipotassium 1-Hydroxyethylidene-1,1-diphosphonic acid consisting of 0.18-0.19 weight % of Manganese (Mn) source, 0.30-0.40 weight % of Potassium (K₂O) source and 0.45-0.55 weight % of Phosphorus (P₂O₅) source that of total weight of Manganese-Potassium-Phosphorus source on anhydrous basis.

In forth embodiment of the present invention, the chelated complex of copper dipotassium 1-Hydroxyethylidene-1,1-diphosphonic acid consisting of 0.205-0.215 weight % of Copper (Cu) source, 0.30-0.40 weight % of Potassium (K₂O) source and 0.40-0.50 weight % of Phosphorus (P₂O₅) source that of total weight of copper-Potassium-Phosphorus source on anhydrous basis.

In fifth embodiment of the present invention, the chelated complex of Magnesium dipotassium 1-Hydroxyethylidene-1,1-diphosphonic acid consisting of 0.085-0.095 weight % of Magnesium (Mg) source, 0.30-0.40 weight % of Potassium (K₂O) source and 0.50-0.60 weight % of Phosphorus (P₂O₅) source that of total weight of Magnesium-Potassium-Phosphorus source on anhydrous basis.

In sixth embodiment of the present invention, the chelated complex of Cobalt dipotassium 1-Hydroxyethylidene-1,1-diphosphonic acid consisting of 0.19-0.20 weight % of Cobalt (Co) source, 0.30-0.40 weight % of Potassium (K₂O) source and 0.40-0.50 weight % of Phosphorus (P₂O₅) source that of total weight of Cobalt-Potassium-Phosphorus source on anhydrous basis.

In second embodiment of the present invention, the chelated complex of seventh Molybdenum dipotassium 1-Hydroxyethylidene-1,1-diphosphonic acid consisting of 0.28-0.30 weight % of Molybdenum (Mo) source, 0.20-0.30 weight % of Potassium (K₂O) source and 0.40-0.50 weight % of Phosphorus (P₂O₅) source that of total weight of Molybdenum-Potassium-Phosphorus source on anhydrous basis.

In eighth embodiment of the present invention, the chelated complex Chelated complex of Iron potassium 1-Hydroxyethylidene-1,1-diphosphonic acid consisting of 0.19-0.37 weight % of Iron (Fe) source, 0.19-0.40 weight % of Potassium (K₂O) source and 0.40-0.60 weight % of Phosphorus (P₂O₅) source that of total weight of Iron-Potassium-Phosphorus source on anhydrous basis.

In another embodiment of the present invention, the chelated complex of metal potassium based 1-Hydroxyethylidene-1,1-diphosphonic acid consisting of 0.085-0.33 weight % of Metal source, 0.19-0.40 weight % of Potassium (K₂O) source and 0.40-0.60 weight % of Phosphorus (P₂O₅) source and 0.001-0.05 weight % of Boron (B) that of total weight of metal-Potassium-Phosphorus source on anhydrous basis.

In accordance to present invention, the invention also provides a process for preparation of complete water soluble micronutrient chelate complex powder for foliar application, comprising of:
Step 1: Mixing and reacting Metal source, Alkali source and Chelating agent source in stochiometric ratio in water at temperature between 40 to 100° C. with solid concentration between 30% w/w to 60% w/w under continuous stirring,
Step 2: Adjust the resulting solution pH between 4 to 7 to obtain a reaction mass,
Step 3: drying of reaction mass in spray dyer with inlet temperature between 150 to 250° C. and outlet temperature between 95 to 115° C. to obtain a complete water soluble micronutrient chelate complex powder.

Wherein, the Metal source selected from Zinc Ash, Zinc Dust, Zinc Oxide, Zinc Carbonate, Zinc Carbonate Basic, Zinc Hydroxide, Zinc Chloride. Calcium Oxide, Calcium Carbonate, Calcium Hydroxide, Calcium Chloride, Manganese Oxide, Manganese Carbonate, Manganese Hydroxide, Manganese Chloride, Copper Ash, Copper Dust, Copper Oxide, Copper Carbonate, Copper Hydroxide, Copper Carbonate Basic, Copper Chloride, Copper Oxychloride. Magnesium Dust, Magnesium Ribbon, Magnesium Oxide, Magnesium Carbonate, Magnesium Hydroxide, Magnesium Carbonate Basic, Magnesium Chloride, Cobalt Ash, Cobalt Oxide, Cobalt Carbonate, Cobalt Hydroxide, Cobalt Carbonate Basic, Cobalt Chloride, Iron Sulphate, Iron Dust, Iron Red Oxide, Iron Yellow Oxide, Iron Sulphate, Iron Carbonate, Iron Hydroxide, Iron Chloride, Molybdenum Oxide, Molybdenum DiSulphide, Molybdenum Chloride, or mixture thereof.

The non-limiting examples of Alkali source selected from Potassium Hydroxide, Potassium Carbonate, Potassium Chloride, Potassium Molybdate Potassium Borate, Dipotassium Octaborate and Boron Ethanolamine.

The non-limiting examples of Chelating agent source selected from 1-Hydroxyethylidene-1,1-diphosphonic acid, potassium 1-Hydroxyethylidene-1,1-diphosphonic acid and dipotassium 1-Hydroxyethylidene-1,1-diphosphonic acid.

Therefore, as per process explained above the present invention provides a micronutrient based chelated composition for foliar application and preparation process thereof which is having 100% water soluble fully chelated complex of metal-dipotassium HEDP (hydroxy ethylidene di phosphonic acid). Wherein the said complex can form a clear aqueous solution between concentration between 0 to 60% w/w, more preferably, 0.001 to 60% w/w or above without any particle settling, precipitation or sedimentation.

### DETAILED DESCRIPTION OF THE INVENTION

The foregoing summary, as well as the following detailed description of the invention will be better understood when read in conjunction with the appended examples. For the purpose of assisting in the explanation of the invention, the examples are presently preferred and considered illustrative.

Unless defined otherwise, all technical and scientific terms used herein have the same meaning as is commonly understood by one of skill in the art to which the invention(s) belong. As used herein, “100% water soluble”, “100% water soluble without any particle sedimentation after dissolving into a water”, which are be used interchangeably, refer to complex that is freely soluble form of complex and fully chelated. The term “substantially fully chelated” meaning that a majority of the compounds have metals that are chelated and a minority of the compounds have metals that are not chelated. The term “fully chelated” meaning that all of the compounds have metals that are chelated with chelating agent.

The invention belongs to the technical field of agricultural powder form fertilizers, and relates to a foliar application chelated fertilizer comprising micronutrients and phosphorus nutrients. Wherein, micronutrients are selected from Zinc, Calcium, Manganese, Copper, Magnesium, Cobalt, Iron, Molybdenum, Boron.

More preferably, the present invention provides 100% water soluble fully chelated complex of metal-dipotassium HEDP (Hydroxy Ethylidene Di Phosphonic Acid) with clear solubility of 10 to 60% w/w or above that without any particle settling, precipitation or sedimentation.

In one more preferred example, the present invention provides 100% water soluble fully chelated complex of metal-potassium HEDP (Hydroxy Ethylidene Di Phosphonic Acid) with clear solubility of 10 to 60% w/w or above that without any particle settling, precipitation or sedimentation.

The main objective of present invention is that the said powder form of chelated fertilizer for foliar application is 100% water soluble without any particle sedimentation after dissolving into a water. Wherein, Water pH can vary from pH 1 to 12, more preferably between pH 5 to 9.

In accordance to present invention, the present invention provides fertilizer comprising a chelate of dipotassium salt of Hydroxy Ethylidene Di Phosphonic Acid and micronutrients. Not limiting examples of said chelates are:
i) Zinc-dipotassium salt of Hydroxy Ethylidene Di Phosphonic Acid,
ii) Calcium-dipotassium salt of Hydroxy Ethylidene Di Phosphonic Acid,
iii) Manganese-dipotassium salt of Hydroxy Ethylidene Di Phosphonic Acid,
iv) Copper-dipotassium salt of Hydroxy Ethylidene Di Phosphonic Acid,
v) Magnesium-dipotassium salt of Hydroxy Ethylidene Di Phosphonic Acid,
vi) Cobalt-dipotassium salt of Hydroxy Ethylidene Di Phosphonic Acid,
vii) Iron-potassium salt of Hydroxy Ethylidene Di Phosphonic Acid,
viii) Molybdenum-dipotassium salt of Hydroxy Ethylidene Di Phosphonic Acid,
ix) Mixture of above composition with or without Boron content.

The present invention provides a 100% water soluble fully chelated complex of Metal dipotassium HEDP with clear solubility of 10 to 60% w/w or above that without any particle settling, precipitation or sedimentation and having percentage of Metal, Potassium and Phosphorus, comprising of: 7-24 weight % of Metal source, 11.5-31 weight % of Potassium (K₂O) source and 23-48 weight % of Phosphorus (P₂O₅) source with respective total weight of product on anhydrous basis. Wherein, metals are selected from Zinc, Calcium, Manganese, Copper, Magnesium, Cobalt, Iron, Molybdenum, Boron.

Further, the said fertilizer composition is formulated into a powder for or liquid form not limiting to solution or suspension in water having concentration of chelated complex of Metal dipotassium HEDP between 0.0001 to 99.99% w/w. Further, the composition is optionally comprising of formulation excipients for suitable industrial applications.

The present invention provides a 100% water soluble fully chelated complex of Metal potassium HEDP with clear solubility of 10 to 60% w/w or above that without any particle settling, precipitation or sedimentation and having percentage of Metal, potassium and Phosphorus, comprising of: 15-19 weight % of metal, 12-28 weight % of Potassium (K₂O) source and 22-48 weight % of Phosphorus (P₂O₅) source with respective total weight of product on anhydrous basis. Wherein, metal is Iron.

In accordance to one more embodiment, the present invention provides a process for preparation of fertilizer comprising a chelate of dipotassium salt of Hydroxy Ethylidene Di Phosphonic Acid and micronutrients.

Step 1: The individual or combination of Metal source or Alkali+Base Metal Source, individual or combination of Alkali source or Alkali+Base Metal Source or Alkali+Chelating Acid Phosphorous Source & individual or combination of Chelating Acid Phosphorous Source or Alkali+Chelating Acid Phosphorous Source are mixed together in water with the in desired ratio of Metal:Alkali:Phosphorous as an exothermic reaction (temperature between 50 to 100° C.) with solid concentration from 30% w/w to 60% w/w slowly under stirring so that all material will get dissolved completely and clear solution will obtain.

Step 2: Adjust the resulting solution pH between 4 to 7 either by Alkali or by acid Source.

Step 3: Drying wherein drying steps is not limiting to spray drying, Open Pan Evaporation/Vacuum/Tray/Drum/Fluid Bed Drying. Wherein the drying temperature is between room temperature to 100° C. or combination therebetween ranges.

In accordance to present invention, the base Metal Sources are selected from following lists:

Zinc (Zn): —Zinc Ash (Zn), Zinc Dust (Zn), Zinc Oxide (ZnO), Zinc Carbonate (ZnCO₃), Zinc Carbonate Basic (ZnCO₃. Zn(OH)₂), Zinc Hydroxide (Zn(OH)₂), Zinc Chloride (ZnCl₂) preferably Zinc Oxide (ZnO).

Calcium (Ca): —Calcium Oxide (CaO), Calcium Carbonate (CaCO₃), Calcium Hydroxide (Ca(OH)₂), Calcium Chloride (CaCl₂)) preferably Calcium Carbonate (CaCO₃).

Manganese (Mn): —Manganese Oxide (MnO₂), Manganese Carbonate (MnCO₃), Manganese Hydroxide (Mn(OH)₂), Manganese Chloride (MnCl₂) preferably Manganese Carbonate (MnCO₃).

Copper (Cu): —Copper Ash (Cu), Copper Dust (Cu), Copper Oxide (Cu₂O), Copper Carbonate (CuCO₃), Copper Hydroxide (Cu(OH)₂), Copper Carbonate Basic (CuCO₃. Cu(OH)₂), Copper Chloride (CuCl₂), Copper Oxychloride (H₃ClCu₂O) preferably Copper Carbonate Basic (CuCO₃. Cu(OH)₂).

Magnesium (Mg): —Magnesium Dust (Mg), Magnesium Ribbon (Mg), Magnesium Oxide (MgO), Magnesium Carbonate (MgCO₃), Magnesium Hydroxide (Mg(OH)₂), Magnesium Carbonate Basic (MgCO₃. Mg(OH)₂), Magnesium Chloride (MgCl₂), preferably Magnesium Carbonate (MgCO₃).

Cobalt (Co): —Cobalt Ash (Co), Cobalt Oxide (CoO), Cobalt Carbonate (CoCO₃), Cobalt Hydroxide (Co(OH)₂), Cobalt Carbonate Basic (CoCO₃. Mg(OH)₂), Cobalt Chloride (CoCl₂), preferably Cobalt Carbonate (CoCO₃).

Iron (Fe): —Iron Sulphate (FeSO₄), Iron Dust (Fe), Iron Red Oxide (Fe₂O₃), Iron Yellow Oxide (Fe₂O₃), Iron Sulphate (FeSO₄), Iron Carbonate (FeCO₃), Iron Hydroxide (Fe(OH)₃), Iron Chloride (FeCl₂ or F₂Cl₃) preferably Iron Red Oxide (Fe₂O₃).

Molybdenum (Mo): —Molybdenum Oxide (MoO₃), Molybdenum DiSulphide (MoS₂), Molybdenum Chloride (MoCl₅), preferably Molybdenum Oxide (MoO₃). Boron (B): —Boric Acid (H₃BO₃).

In accordance to present invention, the alkali Source is selected from Potassium Hydroxide (KOH), Potassium Carbonate (K₂CO₃), Potassium Chloride (KCl), preferably Potassium Hydroxide (KOH).

In accordance to present invention, the chelating Acid Phosphorous Source is selected from HEDP (C₂H₈O₇P₂) Powder/liquid, dipotassium HEDP (C₂H₆O₇P₂K₂) Powder/liquid form.

In accordance to present invention, the Alkali+Base Metal Source is selected from Potassium Molybdate (K₂MoO₄), Potassium Borate (K₂B₄O₇), Dipotassium Octaborate (K₂₂B₈O₁₃), Boron Ethanolamine (C₂H₈BNO₃ or C₄H₁₄BNO₃ or C₆H₁₈BNO₆).

In an non-limiting embodiment, the second chelate known in the art that can be combined with Metal dipotassium HEDP Chelate of the invention or combinations thereof.

Therefore, the present invention of powder fertilizer having 100% solubility in water comprising of Metal dipotassium HEDP Chelate are stronger than metal Sulfates, Nitrates & Marketed EDTA Chelate product and it is highly soluble, stable in water. Also, it is stable in alkaline and acidic conditions meaning it is available for plants at a wider range of pH levels.

Further, Therefore, the present invention of powder fertilizer having 100% solubility in water comprising of Metal dipotassium HEDP Chelate releases cations and has a high affinity with lead which plays an essential role in detoxification of lead in plants. This prevents plants from the toxic effects of lead.

Therefore, the invention will now be further described with reference to the following examples without being limited thereto.

The fertilizer compositions described above and/or prepared in accord with the foregoing procedures may be applied to the foliage of the plant by conventional methods to deliver readily absorbing micronutrients into the plant tissue or can be applied to the ground surrounding a plant.

### Example 1: Preparation of Powder of Metal-Dipotassium 1-Hydroxyethylidene-1,1-Diphosphonic Acid Chelated Complex as Per Present Invention

Different metal were reacted with chelated agent 1-Hydroxyethylidene-1,1-diphosphonic acid in different molar concentration to achieve a complete metal chelated compound without leaving an unreacted metal therein and achieving a 100% soluble compound for foliar application.

General process steps are as follow:

Step 1: Mixing individual or combination of Metal source, alkali source and Chelating Acid Phosphorous Source in stoichiometry ratio and addition of water, wherein non limiting example of combination of metal and alkali can be used that includes Base Metal Source. The mixing is in water with the said ratio of Metal:Alkali:Phosphorous and reaction is an exothermic reaction and therefore temperature vary from 40 to 100° C. The temperature was maintained by jacketed vessel. The weight of chemical agent in water was preferably having solid concentration from 30% w/w to 60% w/w. The mixing step was performed slowly under stirring so that all material get dissolved and reacted completely and clear solution was obtain.

Step 2: The resulting solution was at pH between 6 to 7 or can be adjusted with acid/base to pH between 4 to 6 or between 6 to 7 as per pH suitable for maximum availability of Metal to plant.

Step 3: Drying: Preferably using The Spray drying of solution with solid concentration from 30% to 60% w/w at an inlet temperature between 150 to 250° C. and outlet Temperature ranges from 95 to 115° C. depending on the moisture content or metal percentages required. If required the powder pulverized or grinded and then sifted through sieve of required mesh size to obtain free flowing powder.

The following table explains the different formulation preparations.

TABLE NO. 1
Different metal Chelated complex

| Example | Chelated | | | |
|---|---|---|---|---|
| no. | compound | Metal source | Alkali source | Chelating agent source |
| Exa-2 | Zinc- | Zinc Oxide | Potassium | 1-Hydroxyethylidene-1,1- |
| | K₂HEDP | | Carbonate | diphosphonic acid |
| Exa-3 | Calcium- | Calcium | Potassium | 1-Hydroxyethylidene-1,1- |
| | K₂HEDP | carbonate | Hydroxide | diphosphonic acid |
| Exa-4 | Manganese- | Manganese | Potassium | 1-Hydroxyethylidene-1,1- |
| | K₂HEDP | Carbonate | Carbonate | diphosphonic acid |
| Exa-5 | Copper- | Copper | Potassium | 1-Hydroxyethylidene-1,1- |
| | K₂HEDP | Carbonate | Hydroxide | diphosphonic acid |
| | | Basic | | |
| Exa-6 | Magnesium- | Magnesium | Potassium | 1-Hydroxyethylidene-1,1- |
| | K₂HEDP | Carbonate | Carbonate | diphosphonic acid |
| Exa-7 | Cobalt- | Cobalt | Potassium | 1-Hydroxyethylidene-1,1- |
| | K₂HEDP | Carbonate | Hydroxide | diphosphonic acid |
| Exa-8 | Iron- | Iron red | Potassium | 1-Hydroxyethylidene-1,1- |
| | KHEDP | oxide | Carbonate | diphosphonic acid |
| Exa-9 | Molybdenum- | Molybdenum | Potassium | 1-Hydroxyethylidene-1,1- |
| | K₂HEDP | Oxide | Hydroxide | diphosphonic acid |

TABLE NO. 2
Concentration of Metal, Potassium and Phosphorous in total weight
of micronutrients of powder

| | | % w/w | % w/w | % w/w |
|---|---|---|---|---|
| | | metal | Potassium | Phosphorous |
| | | wrt total | wrt total | wrt total |
| | | weight of | weight of | weight of |
| Formulation | | Metal-K₂O- | Metal-K₂O- | Metal-K₂O- |
| no. | Metal | P₂O₅ | P₂O₅ | P₂O₅ |
| Exa-2 | Zinc | 0.21 | 0.34 | 0.45 |
| Exa-3 | Calcium | 0.14 | 0.35 | 0.51 |
| Exa-4 | Manganese | 0.18 | 0.35 | 0.47 |
| Exa-5 | Copper | 0.21 | 0.35 | 0.44 |
| Exa-6 | Magnesium | 0.085 | 0.35 | 0.565 |
| Exa-7 | Cobalt | 0.19 | 0.35 | 0.46 |
| Exa-8 | Iron | 0.22 | 0.20 | 0.58 |
| Exa-9 | Molybdenum | 0.28 | 0.25 | 0.47 |

### Example 3: Preparation of Powder of Calcium-Dipotassium 1-Hydroxyethylidene-1,1-Diphosphonic Acid Chelated Complex as Per Present Invention

303 kg of Calcium Carbonate, 340 kg of Potassium Hydroxide and 624 Kg of 1-Hydroxyethylidene-1,1-diphosphonic acid was dissolved in 1000 Liter water. The reaction mass was reacted at temperature between 90 to 100° C. The temperature was maintained by jacketed vessel. The weight of chemical agent in water was about 50% w/w. The resulting solution pH was 6 to 7.

The solution was subjected to spray drying in spray dryer having inlet temperature between 150 to 250° C. and outlet temperature ranges from 95 to 115° C. to obtain free flowing powder.

TABLE NO. 3
Analysis of unreacted metal in chelate as per present invention.

| | | | Wt. | % Metal | |
|---|---|---|---|---|---|
| | | | of Metal | attached | |
| | | | separated | to | Unreacted |
| | | % Metal | from 10% | Chelated | % Metal |
| Formulation | Chelated | in | w/v solution | agent | in |
| no. | compound | powder | (insoluble) | (Soluble) | powder |
| Exa-3 | Calcium- | 12 | 0 | 100 | 0 |
| | K₂HEDP | | | | |

It appears clear from the above results, that the products according to the present invention effectively increase the formation of the maximum concentration of metals in chelated complex (i.e. soluble metal in powder) and allows increasing the concentration of the desired chelated complex for plant applications.

Without wishing to be bound to a specific theory, the Applicant has found that using a part of the specific amount of metal source intended for chelation during the synthesis step of the chelating compound has the advantage of increasing the reaction product which has a higher metal bonded to chelating agent and hence 100% soluble powder synthesis. The overall effect is therefore the increase of the yield of the chelated complex, the reduction of unreacted metal in products and the increase essential soluble and absorbing metal in chelated powder for effective foliar application.

### Example 10: Preparation of Different Formulations Having Different Concentrations of Primary Nutrients as Per Present Invention and Comparison With Marketed Conventional Formulations

### i) for Zinc Dipotassium HEDP Chelate

TABLE NO. 4

| Nutrient Source | TRIAL 1 | TRIAL 2 | TRIAL 3 | TRIAL 4 | TRIAL 5 | TRIAL 6 |
|---|---|---|---|---|---|---|
| Zinc (Zn) % w/w wrt | 0.21 | 0.27 | 0.23 | 0.22 | 0.08 | 0.22 |
| total nutrient weight | | | | | | |
| Potassium K₂O % w/w | 0.34 | 0.34 | 0.29 | 0.35 | 0.41 | 0.30 |
| wrt total nutrient weight | | | | | | |
| Phosphorus (P₂O₅) % | 0.45 | 0.39 | 0.48 | 0.43 | 0.51 | 0.48 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 7 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 5

| | | | Marketed |
|---|---|---|---|
| | | | Formulation |
| | | | (AVA |
| | | | Chemicals |
| | | | Zinc |
| | | | Potassium |
| | | | EDTA |
| Parameter | Trial 4 | Trial 6 | 12-18-00) |
| Zn•K₂O•P₂O₅ ratio in | 18-25.7-37.5 | 17-23.85-40 | 12-18-00 |
| powder | | | |
| Physical form | Free | Free | Powder |
| | flowing | flowing | |
| | powder | powder | |
| 1% EC @ 20° C. in DW | 8.34 | 8.00 | 9.33 |
| mS/cm | | | |
| 1% pH @ 20° C. in DW | 7 | 6.5 | 5.12 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

### ii) For Calcium Dipotassium HEDP Chelate

TABLE NO. 6

| Nutrient Source | TRIAL 1 | TRIAL 2 | TRIAL 3 | TRIAL 4 | TRIAL 5 | TRIAL 6 |
|---|---|---|---|---|---|---|
| Calcium (Ca) % w/w | 0.14 | 0.11 | 0.16 | 0.15 | 0.13 | 0.15 |
| wrt total nutrient weight | | | | | | |
| Potassium K₂O % w/w | 0.35 | 0.40 | 0.29 | 0.34 | 0.26 | 0.30 |
| wrt total nutrient weight | | | | | | |
| Phosphorus (P₂O₅) % | 0.51 | 0.49 | 0.55 | 0.51 | 0.61 | 0.55 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 6.5 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 7

| | | | Marketed |
|---|---|---|---|
| | | | Formulation |
| | | | (New |
| | | | Alliance |
| | | | Dye |
| | | | Chem EDTA |
| | | | Calcium |
| | | | Dipotassium |
| Parameter | Trial 4 | Trial 6 | 9.5-22-00) |
| Ca•K₂O•P₂O₅ ratio in | 11.8-27.8-41.8 | 10.57-24.8-37.4 | 9.5-22-00 |
| powder | | | |
| Physical form | Free | Free | Powder |
| | flowing | flowing | |
| | powder | powder | |
| 1% EC @ 20° C. in DW | 3.35 | 3.30 | 6.90 |
| mS/cm | | | |
| 1% pH @ 20° C. in DW | 7 | 6.5 | 5.45 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |
| After 72 Hr pH | 7 | 6.5 | 5.94 |
| After 72 Hr Clarity of | Clear | Clear | Clear |
| solution | | | |

iii) For Manganese Dipotassium HEDP Chelate

TABLE NO. 8

| Nutrient Source | TRIAL 1 | TRIAL 2 | TRIAL 3 | TRIAL 4 | TRIAL 5 | TRIAL 6 |
|---|---|---|---|---|---|---|
| Manganese (Mn) % w/w | 0.18 | 0.21 | 0.17 | 0.19 | 0.03 | 0.19 |
| wrt total nutrient weight | | | | | | |
| Potassium K₂O % w/w | 0.35 | 0.35 | 0.29 | 0.35 | 0.41 | 0.30 |
| wrt total nutrient weight | | | | | | |
| Phosphorus (P₂O₅) % | 0.47 | 0.44 | 0.54 | 0.46 | 0.56 | 0.51 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 6.5 |
| Batch Clarity before | Clear | Turbid | Turbid | Clear | Turbid | Clear |
| drying | | | | | | |
| 1% Solubility @, 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 9

| | | | Marketed |
|---|---|---|---|
| | | | Formulation |
| | | | (New Alliance |
| | | | Dye Chem |
| | | | Manganese |
| | | | Dipotassium |
| Parameter | Trial 4 | Trial 6 | EDTA 12-20-00) |
| Mn•K₂O•P₂O₅ ratio in | 16.5-24-42.5 | 15-24.5-43 | 12-20-00 |
| powder | | | |
| Physical form | Free | Free | Powder |
| | flowing | flowing | |
| | powder | powder | |
| 1% EC @ 20° C. in DW | 6.65 | 6.4 | 7.72 |
| mS/cm | | | |
| 1% pH @ 20° C. in DW | 7 | 6.5 | 5.06 |
| 1% Solubility @, 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

### iv) For Copper Dipotassium HEDP Chelate

TABLE NO. 10

| Nutrient Source | TRIAL 1 | TRIAL 2 | TRIAL 3 | TRIAL 4 | TRIAL 5 | TRIAL 6 |
|---|---|---|---|---|---|---|
| Copper (Cu) % w/w wrt | 0.205 | 0.22 | 0.23 | 0.215 | 0.08 | 0.215 |
| total nutrient weight | | | | | | |
| Potassium K₂O % w/w | 0.35 | 0.40 | 0.29 | 0.38 | 0.41 | 0.33 |
| wrt total nutrient weight | | | | | | |
| Phosphorus (P₂O₅) % | 0.445 | 0.38 | 0.48 | 0.405 | 0.51 | 0.455 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 6.5 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 11

| | | | Marketed |
|---|---|---|---|
| | | | formulation- |
| | | | Jantha Fish |
| | | | Meal Copper |
| | | | Dipotassium |
| Parameter | Trial 1 | Trial 6 | EDTA 12-18-00 |
| Cu•K₂O•P₂O₅ ratio in | 17-24.5-35 | 16.28-24-36 | 12-18-00 |
| powder | | | |
| Physical form | Free | Free | Powder |
| | flowing | flowing | |
| | powder | powder | |
| 1% EC @ 20° C. in DW | 4.68 | 4.25 | 3.4 |
| mS/cm | | | |
| 1% pH @ 20° C. in DW | 7 | 6.5 | 7 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

### v) For Magnesium Dipotassium HEDP Chelate

TABLE NO. 12

| Nutrient Source | TRIAL 1 | TRIAL 2 | TRIAL 3 | TRIAL 4 | TRIAL 5 | TRIAL 6 |
|---|---|---|---|---|---|---|
| Magnesium (Mg) % | 0.085 | 0.11 | 0.096 | 0.095 | 0.10 | 0.095 |
| w/w wrt total nutrient | | | | | | |
| weight | | | | | | |
| Potassium K₂O % w/w | 0.35 | 0.40 | 0.403 | 0.40 | 0.29 | 0.38 |
| wrt total nutrient weight | | | | | | |
| Phosphorus (P₂O₅) % | 0.565 | 0.49 | 0.501 | 0.505 | 0.61 | 0.525 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 6.5 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 13

| | | | Marketed |
|---|---|---|---|
| | | | Formulation |
| | | | (New Alliance |
| | | | Dye Chem |
| | | | Magnesium |
| | | | Dipotassium |
| Parameter | Trial 4 | Trial 6 | EDTA 6-23-00) |
| Mg•K₂O•P₂O₅ ratio in | 7-25.5-39 | 6.75-25-39.5 | 6-11.5-00 |
| powder | | | |
| Physical form | Free | Free | Powder |
| | flowing | flowing | |
| | powder | powder | |
| 1% EC @ 20° C. in DW | 5.0 | 4.8 | 7.36 |
| mS/cm | | | |
| 1% pH @ 20° C. in DW | 7 | 6.5 | 5.01 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

### vi) For Cobalt Dipotassium HEDP Chelate

TABLE NO. 14

| Nutrient Source | TRIAL 1 | TRIAL 2 | TRIAL 3 | TRIAL 4 | TRIAL 5 | TRIAL 6 |
|---|---|---|---|---|---|---|
| Cobalt (Co) % w/w wrt | 0.19 | 0.21 | 0.21 | 0.20 | 0.08 | 0.20 |
| total nutrient weight | | | | | | |
| Potassium K₂O % w/w | 0.35 | 0.40 | 0.29 | 0.40 | 0.41 | 0.38 |
| wrt total nutrient weight | | | | | | |
| Phosphorus (P₂O₅) % | 0.46 | 0.39 | 0.50 | 0.40 | 0.51 | 0.42 |
| w/w wrt total nutrient | | | | | | |
| weight | | | | | | |
| Batch pH before drying | 6.5 | 6.0 | 6.5 | 7 | 7.2 | 6.5 |
| @ 20° C. | | | | | | |
| 1% pH @ 20° C. in DW | 7 | 6.5 | 7 | 7 | 7.5 | 6.5 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 15

| | | | Marketed |
|---|---|---|---|
| | | | Formulation |
| | | | (Ava Chemicals |
| | | | Cobalt EDTA |
| Parameter | Trial 4 | Trial 6 | Co 13-21-00) |
| Co•K₂O•P₂O₅ ratio in | 15-23-35 | 14-22-36 | 13-121-00 |
| powder | | | |
| Physical form | Free | Free | Powder |
| | flowing | flowing | |
| | powder | powder | |
| 1% EC @, 20° C. in DW | 6.29 | 6.00 | 8.90 |
| mS/cm | | | |
| 1% pH @ 20° C. in DW | 7 | 6.5 | 7 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

vii) For Iron Potassium HEDP Chelate

TABLE NO. 16

| Nutrient Source | TRIAL 1 | TRIAL 2 | TRIAL 3 | TRIAL 4 | TRIAL 5 | TRIAL 6 |
|---|---|---|---|---|---|---|
| Iron (Fe) % w/w wrt | 0.22 | 0.18 | 0.38 | 0.23 | 0.18 | 0.32 |
| total nutrient weight | | | | | | |
| Potassium K₂O % w/w | 0.20 | 0.21 | 0.18 | 0.19 | 0.43 | 0.24 |
| wrt total nutrient weight | | | | | | |
| Phosphorus (P₂O₅) % | 0.58 | 0.61 | 0.44 | 0.58 | 0.39 | 0.44 |
| w/w wrt total nutrient | | | | | | |
| weight | | | | | | |
| Batch pH before drying | 4.5 | 4.0 | 4.5 | 4.5 | 5.0 | 4.3 |
| @, 20° C. | | | | | | |
| 1% pH @ 20° C. in DW | 4.8 | 4.5 | 4.8 | 4.9 | 5.2 | 4.7 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 17

| | | | Marketed |
|---|---|---|---|
| | | | Formulation- |
| | | | Janatha Fish |
| | | | Meal Iron |
| | | | potassium |
| | | | EDTA |
| Parameter | Trial 4 | Trial 6 | 12-10-00) |
| Fe•K₂O•P₂O₅ ratio in | 18.21-15.35- | 17.1-12.8-23.15 | 12-10-00 |
| powder | 46.27 | | |
| Physical form | Free | Free | Powder |
| | flowing | flowing | |
| | powder | powder | |
| 1% EC @ 20° C. in DW | 10.7 | 10.5 | 17 |
| mS/cm | | | |
| 1% pH @ 20° C. in DW | 4.9 | 4.7 | 6.50 |
| 1% Solubility @ 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

viii) For Molybdenum Dipotassium HEDP Chelate

TABLE NO. 18

| Nutrient Source | TRIAL 1 | TRIAL 2 | TRIAL 3 | TRIAL 4 | TRIAL 5 | TRIAL 6 |
|---|---|---|---|---|---|---|
| Molybdenum (Mo) % | 0.28 | 0.31 | 0.31 | 0.30 | 0.18 | 0.30 |
| w/w wrt total nutrient | | | | | | |
| weight | | | | | | |
| Potassium K₂O % w/w | 0.25 | 0.30 | 0.19 | 0.30 | 0.31 | 0.25 |
| wrt total nutrient weight | | | | | | |
| Phosphorus (P₂O₅) % | 0.47 | 0.39 | 0.50 | 0.40 | 0.51 | 0.45 |
| w/w wrt total nutrient | | | | | | |
| weight | | | | | | |
| Batch pH before drying | 6.5 | 6.0 | 6.5 | 6.7 | 7.2 | 6.3 |
| @ 20° C. | | | | | | |
| 1% pH @ 20° C. in DW | 7 | 6.5 | 7 | 7 | 7.5 | 6.9 |
| Batch Clarity before | Clear | Turbid | Turbid | Clear | Turbid | Clear |
| drying | | | | | | |
| 1% Solubility @ 20° C. | Clear | Turbid | Turbid | Clear | Turbid | Clear |
| Settling 1% Solubility | Clear | Turbid | Turbid | Clear | Turbid | Clear |
| @ 20° C. | | | | | | |

TABLE NO. 19

| | | | Marketed |
|---|---|---|---|
| | | | Formulation |
| | | | (Anand Agro |
| | | | Chemicals |
| | | | Insta |
| | | | Potassium |
| | | | Molybdate |
| Parameter | Trial 4 | Trial 6 | 39.5-38.5-00) |
| Mo•K₂O•P₂O₅ ratio in | 20.5-20-30 | 20-19-30.5 | 39.5-38.5-00 |
| powder | | | |
| Physical form | Free | Free | Crystal |
| | flowing | flowing | |
| | powder | powder | |
| 1% EC @ 20° C. in DW | 5.5 | 5.8 | 9.0 |
| mS/cm | | | |
| 1% pH @ 20° C. in DW | 7 | 6.9 | 6.5 |
| 1% Solubility @, 20° C. | Clear | Clear | Clear |
| Settling 1% Solubility | Clear | Clear | Clear |
| @ 20° C. | | | |
| Clarity | Clear | Clear | Clear |
| Water solubility | Clear | Clear | Clear |

Comparison of present invention vs conventional EDTA based product: From above tables results clearly demonstrate that the present invention product is comprising more metal in chelated form and additionally phosphorus content provided in compared to the conventional Metal-potassium EDTA complex.

These compounds are widely used as scale inhibitor, deflocculant, sequestrant and water stabilizer. It means when Metal dipotassium HEDP Chelate reacts with water chemical impurities and settles down them at the bottom of formulation (like Alum in water purifying) and stabilizes the formulation. Thus, provides only purified material to crop/plant.

### Advantages of Present Invention

First and most importantly, the present invention of Metal Dipotassium HEDP Chelate are 100% water soluble giving clear solubility without any settling or turbidity.

From above studies it has been proved that the present invention Metal Dipotassium HEDP Chelate contains 15% to 22% higher amount of Potash content and 16% to 22% higher amount of Metal on anhydrous basis than Dipotassium EDTA Chelate.

It ensures lower dosages are required to fulfill plant's nutrient need & is economically beneficial to the farmer.

Metal Dipotassium HEDP chelate has 58% higher chelation value than EDTA Chelate which makes present invention chelate more stable and easily available for plants.

Further, this Metal Dipotassium HEDP Chelate has 14% TO 22% less molecular weight than EDTA Chelate and size which increases rate of trace element absorption through leaf cuticles. That means plant/crop requires very less energy to break the bond of metal-HEDP Chelate and also to digest it. It also means that the said Metal Dipotassium HEDP Chelate are easy to assimilate & digest than any other Chelate.

Due to low cost and phenomenal performance present invention Metal Dipotassium HEDP Chelate chelates are more economical.

The said Metal Dipotassium HEDP Chelate is stronger than Sulfates, Nitrates & Market EDTA Chelate product and it is highly soluble, stable in water. Also, it is stable in alkaline and acidic conditions meaning it is available for plants at a wider range of pH levels. Metal Dipotassium HEDP Chelate releases cations and has a high affinity with lead which plays an essential role in detoxification of lead in plants. This prevents plants from the toxic effects of lead.

The Metal dipotassium HEDP Chelate is hard to be hydrolyzed, and hard to be decomposed under ordinary light and heat conditions. The decomposition of Metal dipotassium HEDP Chelate in water solution at 500° C. i.e. superior resistance to decomposition and therefore, it shows good thermal stability range. And strong stability constants, allowing for increased compatibility and phosphate (PO⁴⁻) stability.

A substantial amount of toxicological data and information demonstrates that there is no evidence for HEDP Chelate being cytotoxic, genotoxic, mutagenic or carcinogenic. It means HEDP Chelate are more safer than EDTA Chelate.

The Metal Dipotassium HEDP Chelate removes unwanted heavy metals like Pb, Hg and Ca scale formation than EDTA which helps farmer's equipment from corrosion and scale formation and it is an excellent deposit control agent than EDTA.

Its acid/alkali and chlorine oxidation tolerance are better than that of EDTA which means Metal dipotassium HEDP Chelate has higher durability of product for longer time than EDTA Chelate.

The final solution for foliar application is showing pH between 4 to 7 and researcher already has provided benefits & plant availability of nutrients by using fertilizer at neutral pH except Iron potassium HEDP as the research shows that pH range Iron maximum availability to plant is between 4 to 6. The invented product has neutral pH it is very safe and absolutely not harmful for crops and plants with highest benefits also the plant availability of Metal-P₂O₅ is maximum with no risk of scorching and very safe and intended to give crop and plant highest benefits with maximum uptake.

Further, Optimum Electrical Conductivity ensures that the nutrients are carried with the help of electric current to charged surface (Cortex Cell) within the root hairs & leaf stomata.

### Example 11: Comparison of Efficacy of Present Invention Fertilizer Formulation Prepared in Example 3 (Calcium) Trial 3 and Trial 4

Field trials were carried out in order to assess the efficacy of the chelated fertilizer having 12% of Calcium described above in present invention when foliar sprayed on to a crop.

The trials were carried out using Chili (Capsicum) crop grown in open field of Western region of Maharashtra. Details of treatments are listed below:

TABLE NO. 20
Description of the treatment groups:

| | | | | Concentration of |
|---|---|---|---|---|
| | | | | primary nutrients in |
| | | | | % w/v in diluted |
| | | Dilution | | solution |
| | | per liter | Solution | (Calcium:Potassium: |
| Description of the treatment | | of water | clarity | Phosphorous) |
| T₁ | Example 10 Trial 3 | 2 g /litre | Turbid | Calcium 0.02334: |
| | (Conventional | | | Potassium 0.0422: |
| | Formulation) | | | Phousphorous 0.080 |
| T₂ | Example 10 Trial 4 | 2 g/litre | Clear | Calcium 0.0236: |
| | (present invention) | | | Potassium 0.0556: |
| | Calcium HEDP | | | Phousphorous 0.0836 |
| T₃ | Control | Plain | Plain | |
| | | water | water | |

Methodology of recording observations: For recording observations five plants were randomly selected and tagged from each net plot. The observations were recorded 4 days before spraying as a pre-treatment and at 5 and 9 days after spraying as post treatment observations.

Time of spraying→1^{st} spraying 30 days after transplanting and 2^{nd} spraying 45 days after first spraying.

TABLE NO. 21
Result of efficacy of formulation on plant height (cm).

| | | Plant height (cm) | | | | |
|---|---|---|---|---|---|---|
| | | 1^{st} | | 2^{nd} | | |
| | | Spraying | | Spraying | | |
| Tr. | | 5 | 9 | 5 | 9 | At last |
| No. | Treatments | DAS | DAS | DAS | DAS | picking |
| T₁ | Example 10-Trial 3 | 21.9 | 25.4 | 31.2 | 33.8 | 80.4 |
| T₂ | Example 10-Trial 1 | 25.7 | 28.9 | 37.6 | 40.3 | 87.3 |
| | (Present invention) | | | | | |
| | Calcium HEDP | | | | | |
| T₃ | Control | 18.9 | 20.8 | 26.7 | 29.2 | 70.1 |

DAS: Days after sowing
Conclusion: On the basis of field experimentation conducted for evaluation of bio-efficacy of present invention formulation on crop during summer season, it was concluded that the treatments (T₂) was found to be the best treatments for improving plant growth and yield as compared to the other trial T₁ and without fertilizer treatment T₃.

We claim:

1. A complete water soluble micronutrient chelate complex powder for foliar application having source of Metal, Potassium and Phosphorus comprising of:
Chelated complex of metals potassium based 1-Hydroxyethylidene-1,1-diphosphonic acid, wherein the complex consisting of 0.085-0.33 weight % of Metal source, 0.19-0.40 weight % of Potassium (K₂O) source and 0.40-0.60 weight % of Phosphorus (P₂O₅) source that of total weight of Metal-Potassium-Phosphorus source on anhydrous basis;
Charactered in that the metal is fully chelated with potassium based 1-Hydroxyethylidene-1,1-diphosphonic acid (HEDP) with clear solubility in water without any settling.

2. The complete water soluble micronutrient chelate complex powder for foliar application as claimed in claim 1, wherein the metals are selected from Zinc, Calcium, Manganese, Copper, Magnesium, Cobalt, Iron, Molybdenum, Boron or mixture thereof.

3. The complete water soluble micronutrient chelate complex powder for foliar application as claimed in claim 1, wherein potassium based 1-Hydroxyethylidene-1,1-diphosphonic acid is selected from potassium and dipotassium form.

4. The complete water soluble micronutrient chelate complex powder for foliar application as claimed in claim 1, wherein Chelated complex zinc dipotassium 1-Hydroxyethylidene-1,1-diphosphonic acid consisting of 0.21-0.22 weight % of Zinc (Zn) source, 0.30-0.40 weight % of Potassium (K₂O) source and 0.40-0.50 weight % of Phosphorus (P₂O₅) source that of total weight of Zinc-Potassium-Phosphorus source on anhydrous basis.

5. The complete water soluble micronutrient chelate complex powder for foliar application as claimed in claim 2, wherein Chelated complex Calcium dipotassium 1-Hydroxyethylidene-1,1-diphosphonic acid consisting of 0.14-0.15 weight % of Calcium (Ca) source, 0.30-0.40 weight % of Potassium (K₂O) source and 0.50-0.60 weight % of Phosphorus (P₂O₅) source that of total weight of Calcium-Potassium-Phosphorus source on anhydrous basis.

6. The complete water soluble micronutrient chelate complex powder for foliar application as claimed in claim 2, wherein Chelated complex Manganese dipotassium 1-Hydroxyethylidene-1,1-diphosphonic acid consisting of 0.18-0.19 weight % of Manganese (Mn) source, 0.30-0.40 weight % of Potassium (K₂O) source and 0.45-0.55 weight % of Phosphorus (P₂O₅) source that of total weight of Manganese-Potassium-Phosphorus source on anhydrous basis.

7. The complete water soluble micronutrient chelate complex powder for foliar application as claimed in claim 2, wherein Chelated complex copper dipotassium 1-Hydroxyethylidene-1,1-diphosphonic acid consisting of 0.205-0.215 weight % of Copper (Cu) source, 0.30-0.40 weight % of Potassium (K₂O) source and 0.40-0.50 weight % of Phosphorus (P₂O₅) source that of total weight of copper-Potassium-Phosphorus source on anhydrous basis.

8. The complete water soluble micronutrient chelate complex powder for foliar application as claimed in claim 2, wherein Chelated complex Magnesium dipotassium 1-Hydroxyethylidene-1,1-diphosphonic acid consisting of 0.085-0.095 weight % of Magnesium (Mg) source, 0.30-0.40 weight % of Potassium (K₂O) source and 0.50-0.60 weight % of Phosphorus (P₂O₅) source that of total weight of Magnesium-Potassium-Phosphorus source on anhydrous basis.

9. The complete water soluble micronutrient chelate complex powder for foliar application as claimed in claim 2, wherein Chelated complex Cobalt dipotassium 1-Hydroxyethylidene-1,1-diphosphonic acid consisting of 0.19-0.20 weight % of Cobalt (Co) source, 0.30-0.40 weight % of Potassium (K₂O) source and 0.40-0.50 weight % of Phosphorus (P₂O₅) source that of total weight of Cobalt-Potassium-Phosphorus source on anhydrous basis.

10. The complete water soluble micronutrient chelate complex powder for foliar application as claimed in claim 2, wherein Chelated complex Molybdenum dipotassium 1-Hydroxyethylidene-1,1-diphosphonic acid consisting of 0.28-0.30 weight % of Molybdenum (Mo) source, 0.20-0.30 weight % of Potassium (K₂O) source and 0.40-0.50 weight % of Phosphorus (P₂O₅) source that of total weight of Molybdenum-Potassium-Phosphorus source on anhydrous basis.

11. The complete water soluble micronutrient chelate complex powder for foliar application as claimed in claim 2, wherein Chelated complex of Iron potassium 1-Hydroxyethylidene-1,1-diphosphonic acid consisting of 0.19-0.37 weight % of Iron (Fe) source, 0.19-0.40 weight % of Potassium (K₂O) source and 0.40-0.60 weight % of Phosphorus (P₂O₅) source that of total weight of Iron-Potassium-Phosphorus source on anhydrous basis.

12. The complete water soluble micronutrient chelate complex powder for foliar application as claimed in claim 1, wherein Chelated complex of metal potassium based 1-Hydroxyethylidene-1,1-diphosphonic acid consisting of 0.085-0.33 weight % of Metal source, 0.19-0.40 weight % of Potassium (K₂O) source and 0.40-0.60 weight % of Phosphorus (P₂O₅) source and 0.001-0.05 weight % of Boron (B) that of total weight of metal-Potassium-Phosphorus source on anhydrous basis.

13. A process for preparation of complete water soluble micronutrient chelate complex powder for foliar application as claimed in claims 1 to 12, comprising of:
Step 1: Mixing and reacting Metal source, Alkali source and Chelating agent source in stochiometric ratio in water at temperature between 40 to 100° C. with solid concentration between 30% w/w to 60% w/w under continuous stirring,
Step 2: Adjust the resulting solution pH between 4 to 7 to obtain a reaction mass,
Step 3: drying of reaction mass in spray dyer with inlet temperature between 150 to 250° C. and outlet temperature between 95 to 115° C. to obtain a complete water soluble micronutrient chelate complex powder.

14. The process for preparation of complete water soluble micronutrient chelate complex powder as claimed in claim 13, wherein Metal source selected from from Zinc Ash, Zinc Dust, Zinc Oxide, Zinc Carbonate, Zinc Carbonate Basic, Zinc Hydroxide, Zinc Chloride. Calcium Oxide, Calcium Carbonate, Calcium Hydroxide, Calcium Chloride, Manganese Oxide, Manganese Carbonate, Manganese Hydroxide, Manganese Chloride, Copper Ash, Copper Dust, Copper Oxide, Copper Carbonate, Copper Hydroxide, Copper Carbonate Basic, Copper Chloride, Copper Oxychloride. Magnesium Dust, Magnesium Ribbon, Magnesium Oxide, Magnesium Carbonate, Magnesium Hydroxide, Magnesium Carbonate Basic, Magnesium Chloride, Cobalt Ash, Cobalt Oxide, Cobalt Carbonate, Cobalt Hydroxide, Cobalt Carbonate Basic, Cobalt Chloride, Iron Sulphate, Iron Dust, Iron Red Oxide, Iron Yellow Oxide, Iron Sulphate, Iron Carbonate, Iron Hydroxide, Iron Chloride, Molybdenum Oxide, Molybdenum DiSulphide, Molybdenum Chloride, or mixture thereof.

15. The process for preparation of complete water soluble micronutrient chelate complex powder as claimed in claim 13, wherein Alkali source selected from Potassium Hydroxide, Potassium Carbonate, Potassium Chloride, Potassium Molybdate Potassium Borate, Dipotassium Octaborate and Boron Ethanolamine.

16. The process for preparation of complete water soluble micronutrient chelate complex powder as claimed in claim 13, wherein Chelating agent source selected from 1-Hydroxyethylidene-1,1-diphosphonic acid, potassium 1-Hydroxyethylidene-1,1-diphosphonic acid and dipotassium 1-Hydroxyethylidene-1,1-diphosphonic acid.
